(19) United States
(12) Patent Application Publication
(10) Pub. No.: US 2003/0004991 A1
(43) Pub. Date: Jan. 2, 2003

(54) Correlating handwritten annotations to a document

(76) Inventors: Dhananjay V. Keskar, Beaverton, OR (US); John J. Light, Beaverton, OR (US); Alan B. McConkie, Gaston, OR (US)

Correspondence Address: FISH & RICHARDSON, PC, 4350 LA JOLLA VILLAGE DRIVE, SUITE 500, SAN DIEGO, CA, 92122, US

(21) Appl. No.: 09/896,123

(22) Filed: Jun. 29, 2001

(51) Int. Cl. G06F 17/24

(52) U.S. Cl. 707/512; 707/541

(57) ABSTRACT

An electronic image of a document that includes a printed text portion and a handwritten portion is formed, and a part of the printed text portion in the image is identified as being associated with the handwritten portion. A correlation between a digital version of the handwritten portion and digital text representing the previously-identified part of the printed text portion is stored.

### BACKGROUND

The invention relates to correlating handwritten annotations to a document.

Writing on paper is a common technique for making comments and other annotations with respect to paper-based content. For example, persons attending a corporate meeting during which a document is discussed may find it convenient to write their comments or other annotations directly on the document. Although the annotations may be intended solely for use by the person making them, the annotations also may be useful for other persons.

### BRIEF DESCRIPTION OF THE DRAWINGS

FIG. 1 shows a document with printed text.

FIG. 2 illustrates a system for use in correlating handwritten annotations on the document to an electronic version of the document.

FIG. 3 shows a printed document with handwritten annotations.

FIG. 4 illustrates additional details for correlating handwritten annotations to an electronic version of the document.

FIG. 5 is a flow chart of a method of correlating a handwritten annotation to an electronic version of the document.

### DETAILED DESCRIPTION

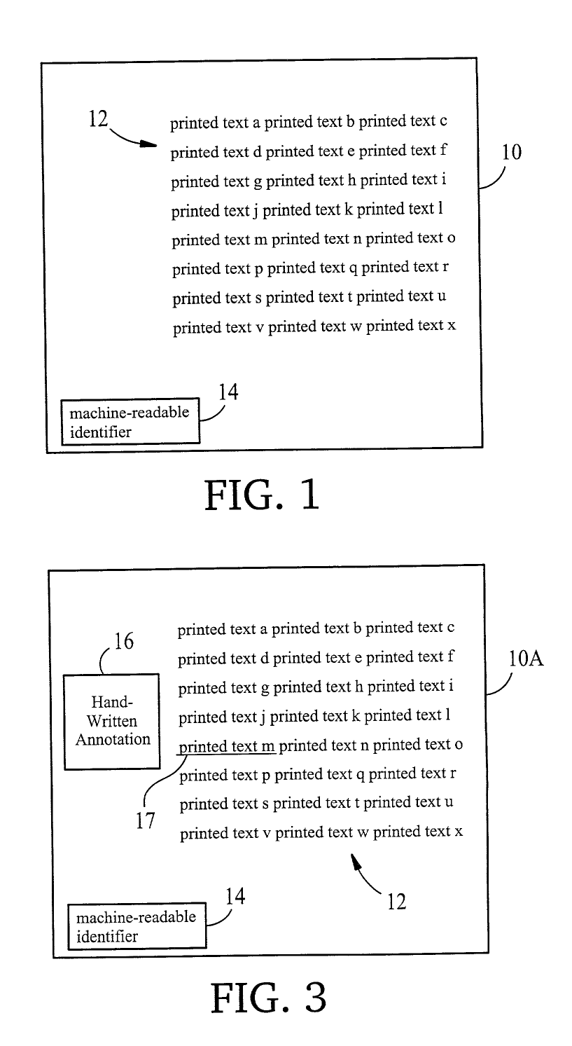

As shown in FIG. 1, an original printed document 10 includes a printed text portion 12. The document can be printed, for example, on paper. In some implementations, the document 10 includes a unique machine-readable identifier 14 such as a bar code. If the document includes multiple pages, a different, machine-readable identifier can be placed on each page.

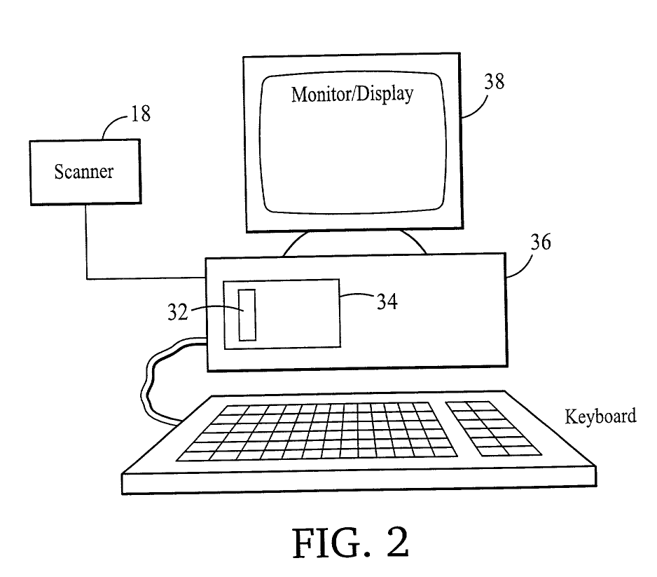

As indicated by FIG. 2, an electronic version 32 of the text portion 12 of the original document is stored in memory 34 such as a hard-disk of a word processor, personal computer or other computer system 36. The electronic version 32 includes digital text corresponding to the printed text portion 12 of the original document. The machine-readable identifiers 18, if any, are stored in the memory 34 and are associated with the electronic version 32 of the document. An optical scanner 18 is coupled to the processor 36.

For purposes of illustration, it is assumed that an individual makes one or more handwritten annotations on the original printed document 10 resulting in an annotated document 10A (FIG. 3). The annotations 16 may include, for example, comments or suggestions by a person reviewing the document. In another scenario, the annotations 16 may include notes made on a document handed out at a meeting. The annotations 16 may include other handwritten notes, comments or suggestions that relate in some way to the printed text portion 12 of the document.

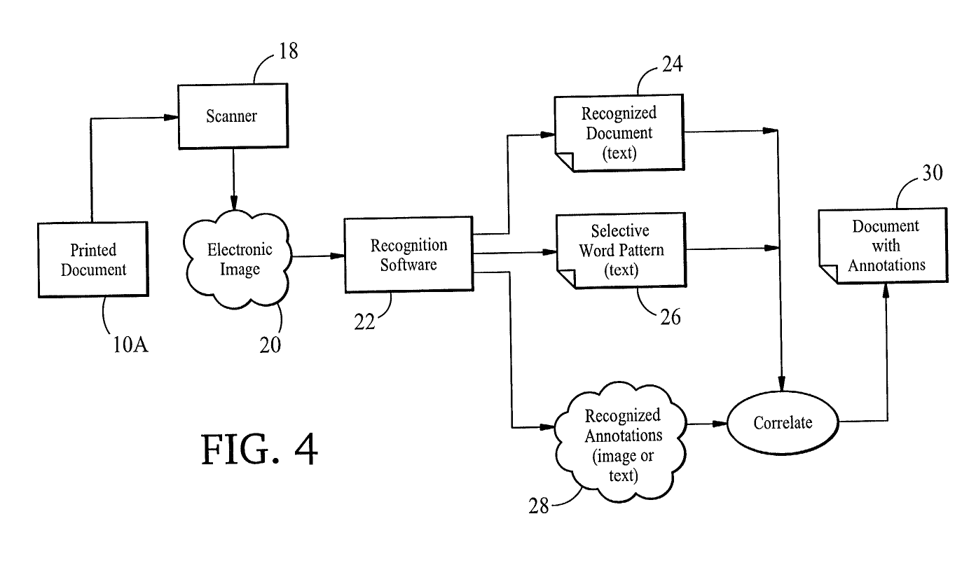

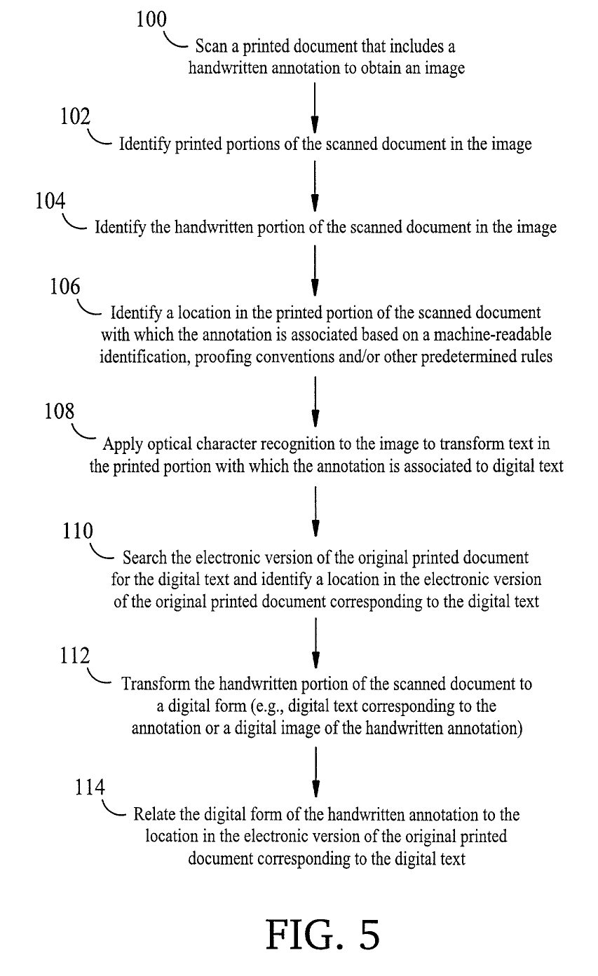

As shown in FIGS. 4 and 5, the printed version of the document 10A with the handwritten annotation 16 is scanned 100 by the scanner 18. An electronic image 20 of the scanned document is retained by the system's memory 34. A keypad (not shown) coupled to the scanner 18 can be used to enter information that identifies the document as well as the person who made the annotations.

In an alternative implementation, instead of scanning the document, the electronic image 20 can be formed by using high resolution digital photographic techniques.

Instructions, which may be implemented, for example, as a software program 22 residing in memory, cause the system 36 to process the image 20 of the scanned document 10A as described below. The program 22 identifies 102 printed portions of the scanned document 10A from the image 20 and also identifies 104 handwritten portions of the document. The printed portions 12 of the document 10A can be identified based, for example, on characteristics that tend to distinguish printed information from handwritten information. In some situations, the printed information 12 is likely to be uniform. Thus, spacings between words, between lines and between paragraphs are likely to be consistent throughout the document. Similarly, the printed letters are likely to share font attributes such as ascenders, descenders and curves. Furthermore, the printed information 12 is likely to be neat. One or both margins are likely to be aligned, and lines are likely to be horizontal and parallel. Those or similar characteristics can be used to identify the printed portions of the annotated document 10A based on the stored electronic image 20.

To facilitate analysis of the electronic image 20, image processing techniques can be applied in conjunction with Hough transforms so that each line of text printed in a particular size is transformed into a horizontal line. The software 22 then would analyze the resulting lines to determine their uniformity. Similarly, templates based on font attributes can be applied to each line of text to ascertain uniformity and, thereby, classify elements as printed or non-printed text. Some templates may be based, for example, on the curves of letters such as “d,” “b,” and “p,” on the descenders in letters such as “g” and “j,” or on the ascenders in letters such as “h,” “d” and “b.”

The handwritten annotations can be identified, for example, by a lack of some or all of the foregoing characteristics.

The software 22 identifies 106 a part of the printed portion 12 of the scanned document 10A with which a particular annotation is associated. The part of the printed document with which the annotation is associated may be, for example, a particular page, a particular paragraph, a particular sentence, a particular phrase or a particular word. The machine-readable identifiers 14 (if any) can be used in conjunction with the information previously stored in memory 34 to facilitate identification of the document and page 24 (FIG. 4) on which the annotation appears. Proofing conventions can be used to associate the annotation with a particular line or other section of the printed text 12.

For example, as illustrated in FIG. 3, underlining may indicate that the annotation 16 is associated with the underlined text 17. Proofing conventions, such as vertical lines in the margin and highlighted or circled words, can be used to associate the annotation 16 with a particular section of the printed text 12. Other proofing conventions may include the use of a caret to indicate an insertion point, an arrow to associate comments with particular words or phrases. A combination of line recognition and pattern recognition techniques can be used to find and interpret such symbols. In the absence of such marks, the annotation 16 simply can be associated with an adjacent or closest line of printed text 12.

After identifying a particular location of the text portion 12 of the scanned image 20 that is associated with a specific annotation 16, an optical character recognition (OCR) technique can be applied 108 to the text in the identified location. The OCR technique transforms the text in the particular location of the image to digital text. For example, if the software program 22 identifies the underlined text 17 (FIG. 3) as the location in the scanned image with which the annotation 16 is associated, an optical character recognition technique can be used to transform that part of the image to digital text. In the illustrated example, the underlined section of the image would be transformed into digital text that reads “printed text m.” The software program 22 then searches 110 the electronic version 32 of the original document 10 to locate the text or selective word pattern 26 (FIG. 4) corresponding to the digital text.

The previously-identified handwritten annotation 16 in the scanned image 20 is transformed 112 to a digital form 28 (FIG. 4). Preferably, handwriting recognition is applied to the handwritten portion 16. The handwritten portion 16 is thereby transformed to digital text. Handwriting recognition software packages are available, for example, from Parascript LLC in Niwot Colo., although other handwriting recognition software can be used as well. To improve the handwriting recognition, skew analysis can be applied to determine the orientation of the handwritten portion 16. The corresponding image can be rotated before applying handwriting recognition. Hough transforms also can be used to facilitate application of the handwriting recognition.

In some cases, the handwriting recognition software may be unable to determine the text corresponding to the handwritten annotation 16. In situations where the handwritten portion 16 cannot be transformed to corresponding digital text, a digital image corresponding to the handwritten portion can be used instead.

The software 22 relates 114 the digital text or image 28 of the handwritten annotation 16 to the text in the electronic version 32 of the original document 10. The digital form 28 of the annotation, as well as the correlation between the digital form of the annotation and the corresponding section of the original document, can be stored in the system's memory 34. That allows an electronic version of the annotated document 30 (FIG. 4) to be stored, where each annotation is correlated to the particular part of the digital text associated with that annotation.

In some implementations, one or more of the following advantages may be provided. Handwritten notes, comments, suggestions and other annotations from multiple sources can be stored electronically and can be associated with the corresponding digital text of the original document. Annotations associated with a particular portion of the original document can be accessed and viewed on a display 38. For example, when the text of the original document 10 is viewed on the display 38, the portion of the text associated with an annotation can appear in highlighted form to indicate that an annotation has been stored in connection with that part of the text. The annotation can be viewed by pointing at the highlighted text using an electronic mouse to cause the text or image of the annotation to appear, for example, in a pop-up screen on the display 38. The name of the person who made the annotation also can appear in the pop-up screen. If the annotation has been transformed to digital text, it can be edited and/or incorporated into a revised electronic version of the original document. The techniques can, therefore, facilitate storage and retrieval of handwritten annotations as well as editing of electronically-stored documents.

Various features of the system can be implemented in hardware, software, or a combination of hardware and software. For example, some features of the system can be implemented in computer programs executing on programmable computers. Each program can be implemented in a high level procedural or object-oriented programming language to communicate with a computer system. Furthermore, each such computer program can be stored on a storage medium, such as read-only-memory (ROM) readable by a general or special purpose programmable computer or processor, for configuring and operating the computer when the storage medium is read by the computer to perform the function described above.

Other implementations are within the scope of the following claims.

what is claimed is:

1. An apparatus comprising:
memory;
a processor coupled to the memory and configured to:
receive an electronic image of a document that includes a printed text portion and a handwritten portion;
identify a part of the printed text portion in the image as being associated with the handwritten portion; and
store in the memory a correlation between a digital version of the handwritten portion and digital text representing the previously-identified part of the printed text portion.

2. The apparatus of claim 1 wherein the processor is configured to identify a portion of the electronic image that represents printed text and identify a portion of the electronic image that represents a handwritten annotation.

3. The apparatus of claim 1 wherein the processor is configured to apply optical character recognition to transform the previously-identified part of the printed text portion to digital text.

4. The apparatus of claim 3 wherein the processor is configured to search a digital text version stored in the memory for the digital text corresponding to the previously-identified part of the printed text portion.

5. The apparatus of claim 1 wherein the processor is configured to:
generate a digital image corresponding to the handwritten portion; and
store in the memory a correlation between the digital image and the digital text that represents the previously-identified part of the printed text portion.

6. The apparatus of claim 1 wherein the processor is configured to:
generate digital text corresponding to the handwritten portion; and
store in the memory a correlation between the digital text representing the handwritten portion and the digital text representing the previously-identified part of the printed text portion.

7. The apparatus of claim 6 wherein the processor is configured to apply handwriting recognition to the handwritten portion to generate the digital text representing the handwritten portion.

8. The apparatus of claim 7 wherein the processor is configured to apply skew analysis to the handwritten portion prior to applying handwriting recognition.

9. The apparatus of claim 1 wherein the processor is configured to:
identify a portion of the scanned image that represents the printed text and identify a portion of the scanned image that represents the handwritten portion;
apply optical character recognition to transform the previously-identified part of the printed text portion of the image to digital text;
search a digital text version stored in the memory for the digital text representing the previously-identified part of the printed text portion;
transform the handwritten portion to digital text; and
store in the memory a correlation between the digital text representing the handwritten portion and the particular digital text corresponding to the previously-identified part of the printed text portion.

10. The apparatus of claim 1 wherein the processor is configured to identify a particular paragraph, a particular sentence, a particular phrase or a particular word in the printed text portion of the image as the part of the printed text portion associated with the handwritten portion.

11. A method comprising:
forming an electronic image of a document comprising a printed text portion and a handwritten portion;
identifying a part of the printed text portion in the image as being associated with the handwritten portion; and
storing a correlation between a digital version of the handwritten portion and digital text representing the previously-identified part of the printed text portion.

12. The method of claim 11 including identifying a portion of the electronic image that represents printed text and identifying a portion of the electronic image that represents a handwritten annotation.

13. The method of claim 11 including applying optical character recognition to transform the previously-identified part of the printed text portion to digital text.

14. The method of claim 13 including searching a digital text version that represents the printed text portion of the document for the digital text corresponding to the previously-identified part of the printed text portion.

15. The method of claim 11 including:
generating a digital image corresponding to the handwritten portion; and
storing a correlation between the digital image and the digital text that represents the previously-identified part of the printed text portion.

16. The method of claim 11 including:
generating digital text corresponding to the handwritten portion; and
storing a correlation between the digital text representing the handwritten portion and the digital text representing the previously-identified part of the printed text portion.

17. The method of claim 16 wherein generating digital text representing the handwritten portion includes applying handwriting recognition to the handwritten portion.

18. The method of claim 17 including applying skew analysis to the handwritten portion prior to applying the handwriting recognition.

19. The method of claim 11 including:
identifying a portion of the electronic image that represents the printed text and identifying a portion of the electronic image that represents the handwritten portion;
applying optical character recognition to transform the previously-identified part of the printed text portion of the image to digital text;
searching a digital text version that represents the printed text portion of the document for the digital text representing the previously-identified part of the printed text portion;
transforming the handwritten portion to digital text; and
storing a correlation between the digital text representing the handwritten portion and the digital text corresponding to the previously-identified part of the printed text portion.

20. The method of claim 11 wherein identifying a part of the printed text portion in the image as being associated with the handwritten portion includes identifying a particular paragraph, a particular sentence, a particular phrase or a particular word in the printed text portion of the image.

21. An apparatus comprising:
a scanner for generating an electronic image of a document that includes a printed text portion and a handwritten portion; and
a processor coupled to the scanner and configured to:
identify a part of the printed text portion in the image as being associated with the handwritten portion; and
store a correlation between a digital version of the handwritten portion and digital text representing the previously-identified part of the printed text portion.

22. The apparatus of claim 21 wherein the processor is configured to identify a portion of the electronic image that represents printed text and identify a portion of the electronic image that represents a handwritten annotation.

23. The apparatus of claim 21 wherein the processor is configured to apply optical character recognition to transform the previously-identified part of the printed text portion to digital text.

24. The apparatus of claim 23 wherein the processor is configured to search a digital text version that represents the printed text portion of the document for the digital text corresponding to the previously-identified part of the printed text portion.

25. The apparatus of claim 21 wherein the processor is configured to:
generate a digital image corresponding to the handwritten portion; and
store a correlation between the digital image and the digital text that represents the previously-identified part of the printed text portion.

26. The apparatus of claim 21 wherein the processor is configured to:
generate digital text corresponding to the handwritten portion; and
store a correlation between the digital text representing the handwritten portion and the digital text representing the previously-identified part of the printed text portion.

27. The apparatus of claim 26 wherein the processor is configured to apply handwriting recognition to the handwritten portion to generate the digital text representing the handwritten portion.

28. The apparatus of claim 27 wherein the processor is configured to apply skew analysis to the handwritten portion prior to applying handwriting recognition.

29. The apparatus of claim 21 wherein the processor is configured to:
identify a portion of the scanned image that represents the printed text and identify a portion of the scanned image that represents the handwritten portion;
apply optical character recognition to transform the previously-identified part of the printed text portion of the image to digital text;
search a digital text version that represents the printed text portion of the document for the digital text representing the previously-identified part of the printed text portion;
transform the handwritten portion to digital text; and
store a correlation between the digital text representing the handwritten portion and the particular digital text corresponding to the previously-identified part of the printed text portion.

30. The apparatus of claim 21 wherein the processor is configured to identify a particular paragraph, a particular sentence, a particular phrase or a particular word in the printed text portion of the image as the part of the printed text portion associated with the handwritten portion.

31. An article comprising a computer-readable medium storing computer-executable instructions for causing a computer system to:
in response to obtaining an electronic image of a document that includes a printed text portion and a handwritten portion, identify a part of the printed text portion in the image as being associated with the handwritten portion; and
store a correlation between a digital version of the handwritten portion and digital text representing the previously-identified part of the printed text portion.

32. The article of claim 31 including instructions for causing the computer system to identify a portion of the electronic image that represents printed text and identify a portion of the electronic image that represents a handwritten annotation.

33. The article of claim 31 including instructions for causing the computer system to apply optical character recognition to transform the previously-identified part of the printed text portion to digital text.

34. The article of claim 33 including instructions for causing the computer system to search a digital text version that represents the printed text portion of the document for the digital text corresponding to the previously-identified part of the printed text portion.

35. The article of claim 31 including instructions for causing the computer system:
generate a digital image corresponding to the handwritten portion; and
store a correlation between the digital image and the digital text that represents the previously-identified part of the printed text portion.

36. The article of claim 31 including instructions for causing the computer system to:
generate digital text corresponding to the handwritten portion; and
store a correlation between the digital text representing the handwritten portion and the digital text representing the previously-identified part of the printed text portion.

37. The article of claim 36 including instructions for causing the computer system to apply handwriting recognition to the handwritten portion to generate the digital text representing the handwritten portion.

38. The article of claim 37 including instructions for causing the computer system to apply skew analysis to the handwritten portion prior to applying handwriting recognition.

39. The article of claim 31 including instructions for causing the computer system to:
identify a portion of the scanned image that represents the printed text and identify a portion of the scanned image that represents the handwritten portion;
apply optical character recognition to transform the previously-identified part of the printed text portion of the image to digital text;
search a digital text version that represents the printed text portion of the document for the digital text representing the previously-identified part of the printed text portion;
transform the handwritten portion to digital text; and
store a correlation between the digital text representing the handwritten portion and the particular digital text corresponding to the previously-identified part of the printed text portion.

40. The article of claim 31 including instructions for causing the computer system to identify a particular paragraph, a particular sentence, a particular phrase or a particular word in the printed text portion of the image as the part of the printed text portion associated with the handwritten portion.
